(19) United States
(12) Patent Application Publication
(10) Pub. No.: US 2021/0115731 A1
(43) Pub. Date: Apr. 22, 2021

(54) APPARATUS AND SYSTEM FOR A CONCEALED SCREEN ASSEMBLY

(71) Applicant: Ply Gem Industries, Inc., Cary, NC (US)

(72) Inventor: EMILY ALEXANDER, CARY, NC (US)

(21) Appl. No.: 16/657,233

(22) Filed: Oct. 18, 2019

(51) Int. Cl. E06B 9/54; E06B 9/66

(52) U.S. Cl. CPC E06B 9/54; E06B 2009/546; E06B 9/66

(57) ABSTRACT

A screen system for use with a sliding sash of a window to screen an opening as the sliding sash is opened includes a longitudinally extending tube and a spring extending through the interior channel of the tube. The system uses cartridge end caps for restraining the longitudinally extending tube in position within a cartridge housing. A mesh screen includes a leading edge, a trailing edge and opposed side edges. The mesh screen is of sufficient length and width to freely span and substantially cover the window opening when uncoiled and is wrapped around the longitudinally extending tube. The trailing edge of the mesh screen is secured to the longitudinally extending tube and the leading edge is attached to the rail of a window sash. The mesh screen can be unwound from the longitudinally extending tube as the sliding sash is opened, and wound back onto the tube as the sliding sash is closing.

### TECHNICAL FIELD

This disclosure is directed to a retractable screen for installation in a window with a movable sash.

### BACKGROUND

Window screens have long been used with windows having sliding panels, e.g., single-hung and slider windows. The screens are typically formed of a woven mesh of metal, plastic, or fiberglass stretched across an outer frame. In most applications, the mesh is sized to deny insects access to the interior of the building. Thus, to be effective, the mesh must be tightly woven. In use, the screens typically are mounted to an external side of a window without inhibiting the operation of a sliding sash of the window. The screen typically is left in place, whether the sash is open or closed. Thus, even with the window closed, view out the window is inhibited. Many consider such screens to be rather unattractive.

Due in part to these concerns, retractable screens have become increasingly popular. In current designs, retractable screens typically include a rolled screen assembly and a pair of parallel tracks for receiving the longitudinal edges of the screen, all externally attached to the window frame. The tracks extend from opposing sides of the rolled screen assembly and are dedicated to retaining the screen as it is unrolled and extended across the frame. The leading edge of the screen typically includes a handle so that a user can manually open and close the screen. In certain designs, the retractable screen is installed into the window frame from the interior side of the window frame, making it accessible to users within the building.

It should, therefore, be appreciated that there remains a need for a retractable screen having an aesthetic look that is cost-effective to manufacture and is easy to use. The apparatus disclosed herein fulfills this need and others.

### SUMMARY

The apparatus disclosed herein resides in a window assembly incorporating a retractable screen assembly. The window assembly includes an external frame configured to interface with a rectangular opening in a wall. The window assembly further includes at least one sliding sash and optionally a stationary sash disposed within the frame. The sliding sash is configured to slide within the confines of the frame between open and closed positions. The retractable screen assembly includes a spool and a screen rolled about the spool, the screen having a leading edge coupled to the sliding sash such that the screen is aligned along the window opening central channel as the sliding panel slides between open and closed positions, the screen assembly having a portion disposed within the central channel.

In an exemplary embodiment of the disclosure, the frame defines a first sash pocket for receiving the stationary panel and a second sash pocket for receiving the sliding panel, the first and second sash pockets aligned parallel to one another on opposing sides of the central channel. The frame preferably defines two central channels spaced from each other on opposing sides of the frame.

In a detailed aspect of an exemplary embodiment, the screen assembly includes a side edge disposed within the central channel. The leading edge of the screen is attached to a pull rail that is removably attached to the sliding sash via a snap-fit. The pull rail includes an end portion disposed within the central channel such that the central channel confines operable movement of the pull rail.

In another exemplary embodiment of the invention, the window assembly includes an external frame having first and second pairs of opposing sides. Each side of the first pair defines first and second sash pockets aligned parallel with each other along the length of the side along an inwardly facing side thereof, and each side further defines a central channel disposed between the first and second sash pockets. The second pair of opposing sides is attached perpendicular to the first pair of opposing sides. The window assembly includes a stationary panel secured to the frame within the first sash pockets of the first pair of opposing sides and a sliding panel disposed within the second sash pockets of the frame. The sliding panel is configured to slide within the confines of the frame between open and closed positions. The retractable screen assembly includes a housing secured along a first side of the second pair of opposing sides. A spool is mounted for rotation within an elongated cavity of the housing. A screen rolled about the spool. The screen has a leading end coupled to the sliding panel such that the screen is aligned along the central channel as the sliding panel slides between open and closed positions, the screen assembly having a portion disposed within the central channel.

In a detailed aspect of an exemplary embodiment, the central channel of each of the sides of the first pair extends substantially the length thereof. The stationary panel can also include two glazing beads, in which each glazing bead is received within a portion of the corresponding central channel adjacent to the stationary panel.

In another detailed aspect of an exemplary embodiment, the screen assembly is a self-contained component and features its own housing separate from the window such that it can be inserted into and removed from the exterior side of the window frame.

For purposes of summarizing the apparatus disclosed herein and the advantages achieved over the prior art, certain advantages of the disclosed apparatus have been described herein. Of course, it is to be understood that not necessarily all such advantages may be achieved in accordance with any embodiment of the disclosed apparatus. Thus, for example, those skilled in the art will recognize that the disclosed apparatus may be embodied or carried out in a manner that achieves or optimizes one advantage or group of advantages as taught herein without necessarily achieving other advantages as may be taught or suggested herein.

These embodiments are intended to be within the scope of the apparatus disclosed herein. These and other embodiments of the disclosure will become clear to those skilled in the art from the following detailed description of the preferred embodiments having reference to the attached figures, the disclosed apparatus not being limited to any particular preferred embodiment disclosed.

Various objects, features, aspects and advantages of the disclosed subject matter will become more apparent from the following detailed description of preferred embodiments, along with the accompanying drawings in which like numerals represent like components. The contents of this summary section are provided only as a simplified introduction to the disclosure, and are not intended to be used to limit the scope of the appended claims.

### BRIEF DESCRIPTION OF THE DRAWINGS

FIG. 1 illustrates a perspective view of a window master frame with an embodiment of the screening apparatus/system installed into the frame;

FIG. 2 illustrates the features of a typical window;

FIG. 3 illustrates an exploded view of an embodiment of the components of the cartridge of the disclosed screening apparatus and system;

FIG. 4 illustrates an embodiment of the first tube end cap and attached spring;

FIG. 5 illustrates an embodiment of the cartridge enclosure apparatus and system;

FIG. 6 illustrates a perspective view of an embodiment of a cartridge first end cap;

FIG. 7 illustrates a perspective view of an embodiment of a cartridge second end cap;

FIG. 8 illustrates a perspective view of an embodiment of the cartridge second end cap and spring ready for assembly in the cartridge;

FIG. 9 illustrates a side elevation view of an embodiment of the cartridge second end cap detailing the assembly posts;

FIG. 10A illustrates a cross sectional elevation view of an embodiment of the screening apparatus and system in position in a window with inner and outer sashes having a meeting rail;

FIG. 10B illustrates a cross sectional elevation view of an embodiment of the screening apparatus and system in position in a window with inner and outer sashes in open positions;

FIG. 11 illustrates a perspective view of an embodiment of the screening apparatus and system in position in a window with inner and outer sashes in open positions;

FIG. 12 illustrates a cross-sectional plan view of an embodiment of one side edge of the screen mesh passing through a flexible trackway;

FIG. 13 illustrates a front elevation view of an embodiment of the apparatus/system disposed atop the sill of a window; and

FIG. 14 illustrates an exploded view of an embodiment of the apparatus for screening a window.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

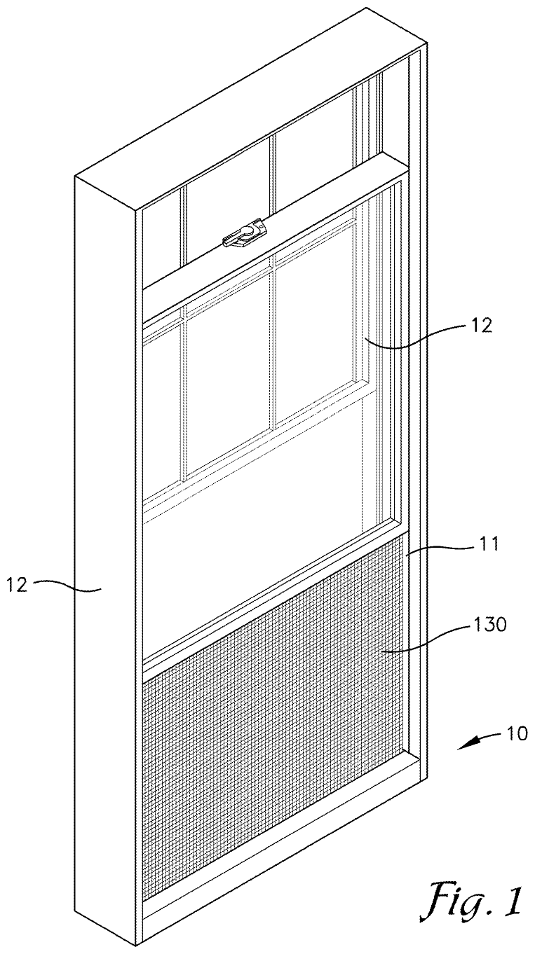

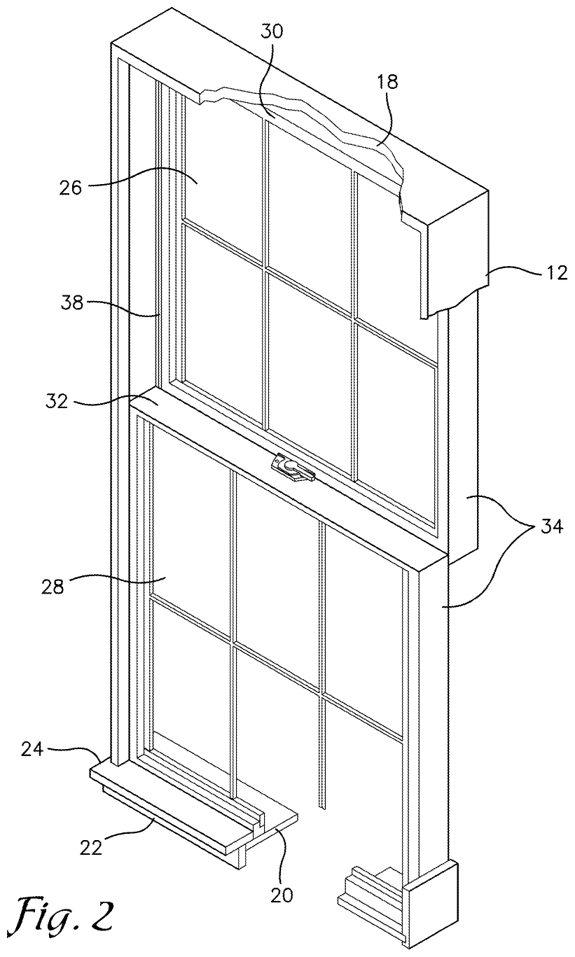

As seen in FIG. 1, disclosed herein is a screening apparatus and system 10 containing a retractable screen mesh 130 configured for spanning and substantially covering an opening 11 in a window. The enclosing structure of a window 12 is the frame 14. The frame supports and surrounds the entire window. As seen in FIG. 2, the window 12 is comprised of numerous components including one or more sashes, a head jamb 18 which is the horizontal part forming the top of the window frame, the sill 20 which is the main horizontal part forming the bottom of the frame, an apron 22 and a stool 24. A window 12 commonly has two sashes, an outer sash 26 and an inner sash 28. Each of the sashes includes an upper rail 30 and a lower rail 32 which are the horizontal members. The vertical members of the sashes 26, 28 are the stiles 34. The jambliner 38 is a strip that resides on the sides of a window frame that provides a snug fit for the window sashes 26, 28.

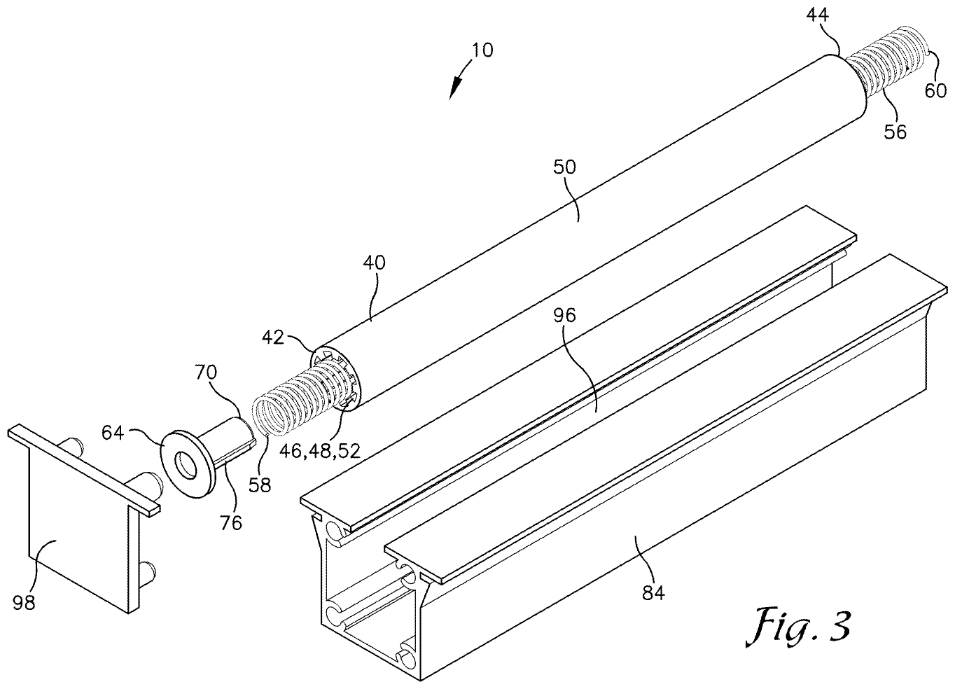

As seen in FIG. 3, the screen system 10 is for use with a sliding sash 26, 28 of a window to screen (prevent insect intrusion) an opening as disclosed herein includes a longitudinally extending tube 40 with a first end 42 and a second end 44. The tube 40 preferably includes an interior channel 46 with an inner diameter 48, an outer diameter 50 and a plurality of spaced apart parallel slots 52 extending longitudinally along the inner diameter 48. The system disclosed herein also includes a spring 56, preferably configured for resisting torsional movement, with first and second ends 58, 60. In an operational mode, the spring 56 extends through the interior channel 46 of the tube 40 and as will be discussed in greater detail below the spring resists rotation of the longitudinal extending tube seeking to retract the mesh screen back into the cartridge.

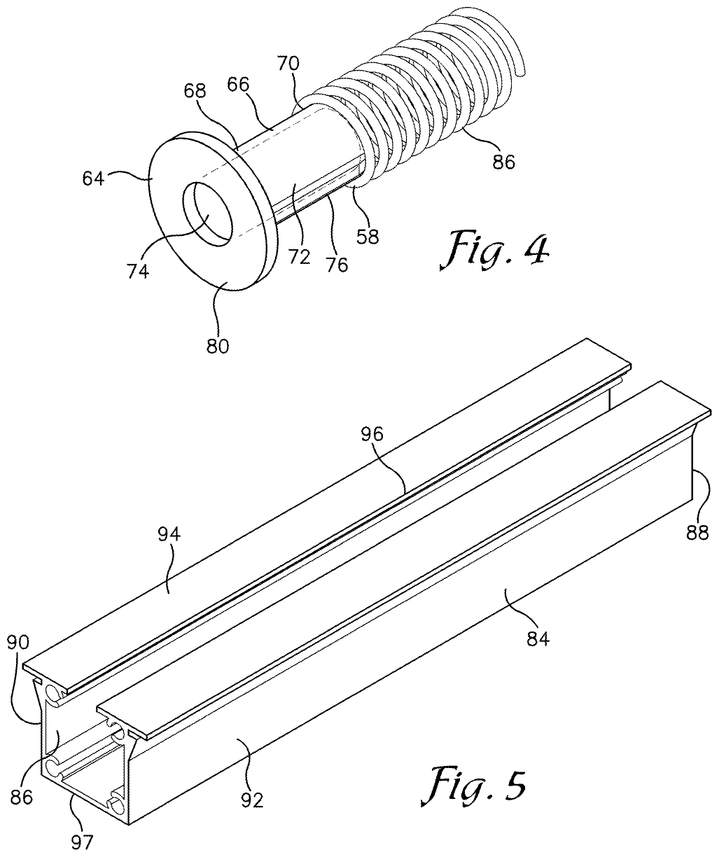

As seen in FIGS. 3 and 4, the screen system 10 disclosed herein also employs a first end tube cap 64 for the first end 42 of the longitudinally extending tube 40. The first tube end cap 64 is a hollow cylinder 66 with a first end 68, a second end 70, an outer radius 72, an inner radius 74 and at least one key 76 disposed on the outer radius 72 for engagement with at least one of the spaced apart slots or keyways 52 of the tube 40. The first end 58 of the spring 56 is secured to the second end 70 of the end cap hollow cylinder 66 and the first end 68 of the hollow cylinder 66 is mounted to a stop plate 80.

FIG. 5 details the longitudinally extending cartridge housing 84 wherein the longitudinally extending tube 40 is disposed within the cartridge housing. The cartridge housing 84 comprising a first end 86 and a second end 88 and a pair of oppositely disposed side walls 90, 92 as well as a third wall 94 extending between the side walls with a longitudinally extending slot 96 therein and a fourth unslotted wall 97 disposed opposite the slotted wall 94 and extending between the side walls 90, 92.

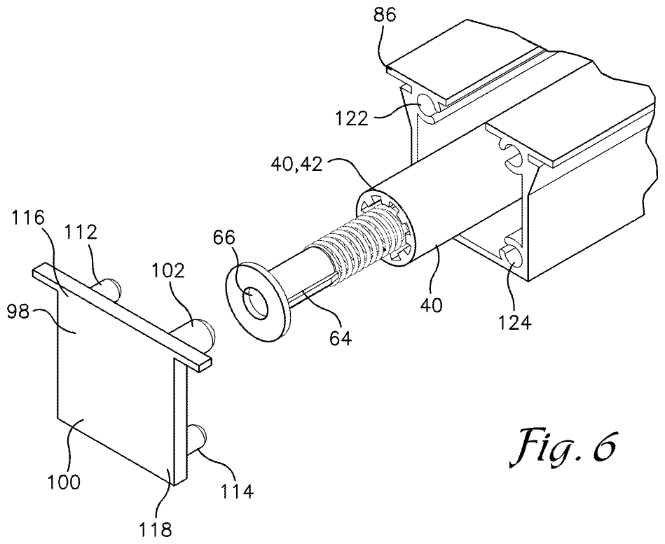

FIG. 6 illustrates a cartridge first end cap 98 for restraining the longitudinally extending tube 40 in position within the cartridge housing 84. The end cap 98 is located at the first end 42 of the tube 40. The cartridge first end cap 98 includes a plate 100 and a mounting rod 102 extending perpendicularly outwardly from the plate, wherein the first cartridge end cap mounting rod 102 is inserted into the hollow cylinder 66 of the first tube end cap 64 and the hollow cylinder 66 is capable of freely rotating about the mounting rod 102.

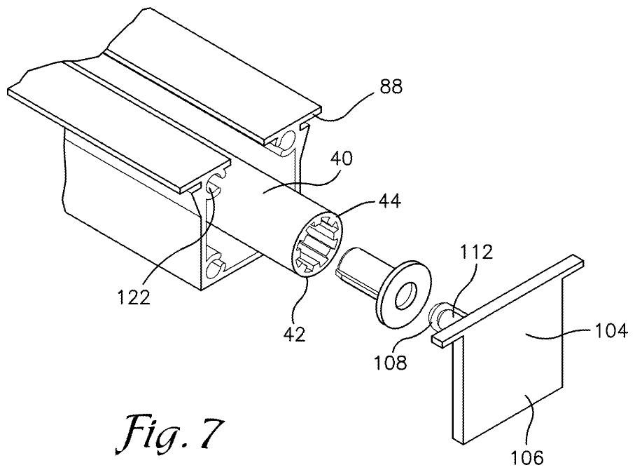

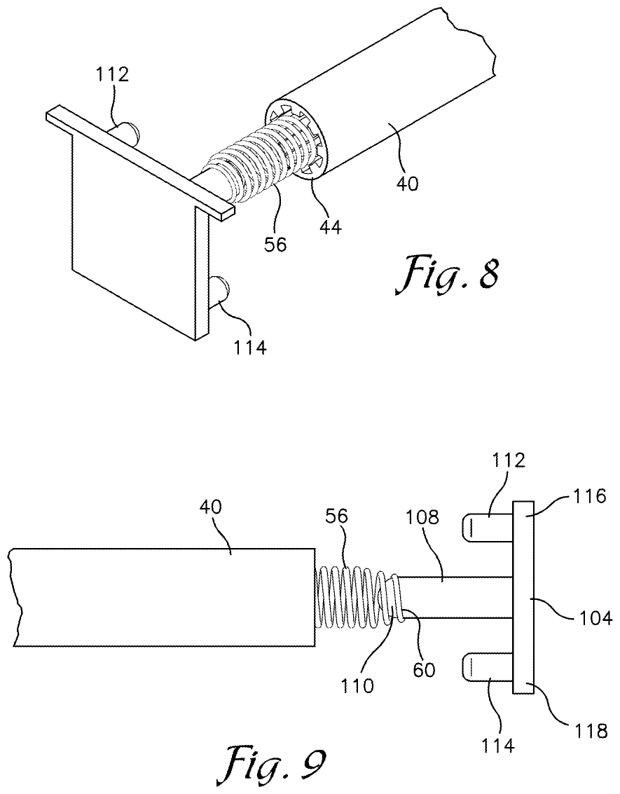

FIG. 7 reveals a cartridge second end cap 104 disposed proximate the second end 44 of the longitudinally extending tube 40. The second cartridge end cap 104 includes a plate 106 and a mounting rod 108 extending perpendicularly outwardly from the plate. As seen in FIG. 9, the second end 60 of the spring 56 is secured to a distal end 110 of the mounting rod 108. FIGS. 6, 8 and 9 illustrate that the first and second cartridge end caps 98, 104 also include first and second posts 112, 114 extending perpendicularly outwardly from the two diagonally opposed corners 116, 118 of the end caps 98, 104. As seen in FIGS. 6 and 7, the first and second posts 112, 114 of the first and second cartridge end caps 98, 104 are received into channels 122, 124 in the first and second ends 86, 88 of the cartridge housing 84. These posts serve to retain the end caps 98, 104 in position at the ends 86, 88 of the cartridge housing 84 and are held in position by a manual press fit between the posts 112, 114 and the channels 122, 124.

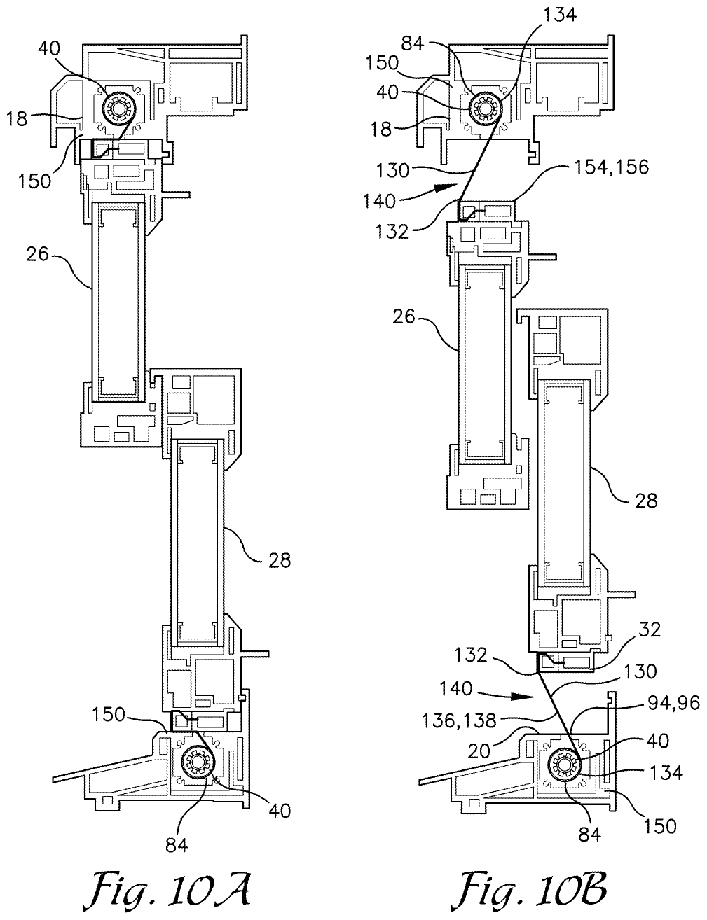

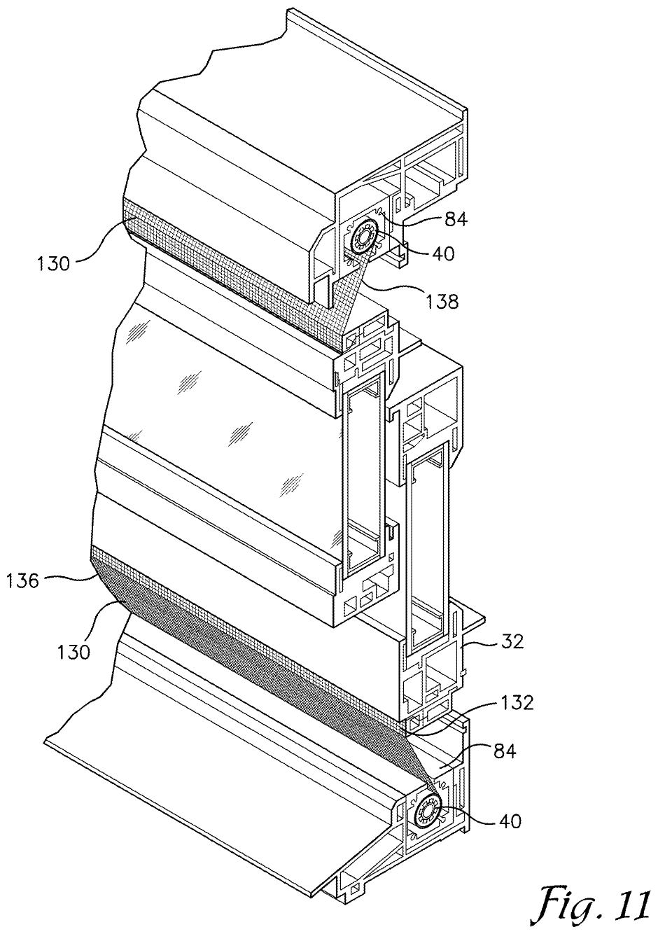

FIGS. 10A and 10B reveal a side elevation cross sectional view of two installed cartridges with the inner and outer sashes 28, 26 in a closed position in FIG. 10A and in an open position in FIG. 10B in a window detailing a mesh screen 130 with a leading edge 132, a trailing edge 134 and opposed side edges 136, 138. The mesh screen 130 is of sufficient length and width to freely span and substantially cover the window opening 140 when uncoiled. The mesh screen 130 is wrapped around the longitudinally extending tube 40 and the trailing edge 134 of the mesh screen 130 is secured to the longitudinally extending tube 40.

The connection of the mesh screen 130 to the tube 40 may be with an adhesive or, for example, a tube slot into which the trailing edge 134 is inserted and folded over to obtain a friction or locking fit. The leading edge 132 is routed through the longitudinally extending slot 96 of the third wall 94 of the cartridge housing 84 for attachment to the rail 32 of a window sash 28. This attachment may be accomplished with, for example, adhesive, magnets, staples or fasteners. The spring 56, through rotational force applied to the tube 40 applies a continuous tension to the screen mesh 130 and thereby maintains a taught and aesthetically appealing appearance.

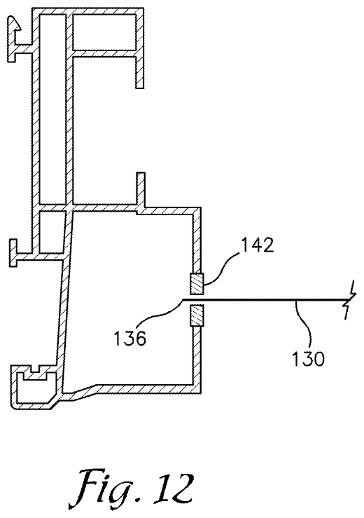

FIG. 11 is a perspective view of FIG. 10B and FIG. 12 is a sectional view of the window frame detailing the passage of an edge 136 of the screen mesh 130 through one of the oppositely disposed trackways 142, 144 proximate the jambliner 38 for guiding the mesh 130 as the mesh leading edge 132 moves up and down with the sash rail 32 to which the leading edge of the mesh screen is attached. The oppositely disposed trackways 142, 144 are preferably comprised of a resilient flexible material that can maintain a slightly compressive seal against the side edges 136, 138 of the mesh 130 as it is withdrawn from and retracted back into the cartridge housing 84. This compressive seal prevents access by insects to the interior of the structure through gaps between the mesh 130 and the jamb liner 38 that may otherwise occur along the oppositely disposed side edges 136, 138 of the mesh element 130.

FIGS. 10A, 10B and 11 illustrate that the cartridge system disclosed herein may be disposed in a cavity 150 below the window sill 20 and beneath the inner sash 28. This configuration of a window screening system 10 removes the cartridge housing 84 from view by all observers, whether viewing from the interior of the structure or the exterior of the structure. The leading edge 132 of the mesh 130 extends outwardly from the longitudinally extending slot 96 in the cartridge housing 84 as noted above and attaches to the rail 32 of a window sash 28. FIGS. 10A and 10B reveal that a cartridge housing 84 may also be placed beneath or alternatively within the head jamb 18 in a position that is superjacent to the top rail 154 of the outer sash 26. In this configuration, the leading edge 132 of the mesh 130 is attached to the upper surface 156 of the top rail 154 of the outer sash 26. As the outer sash 26 is lowered the screen mesh 130 is extracted from the cartridge housing 84 to cover the opening created by the downward movement of the outer sash 26.

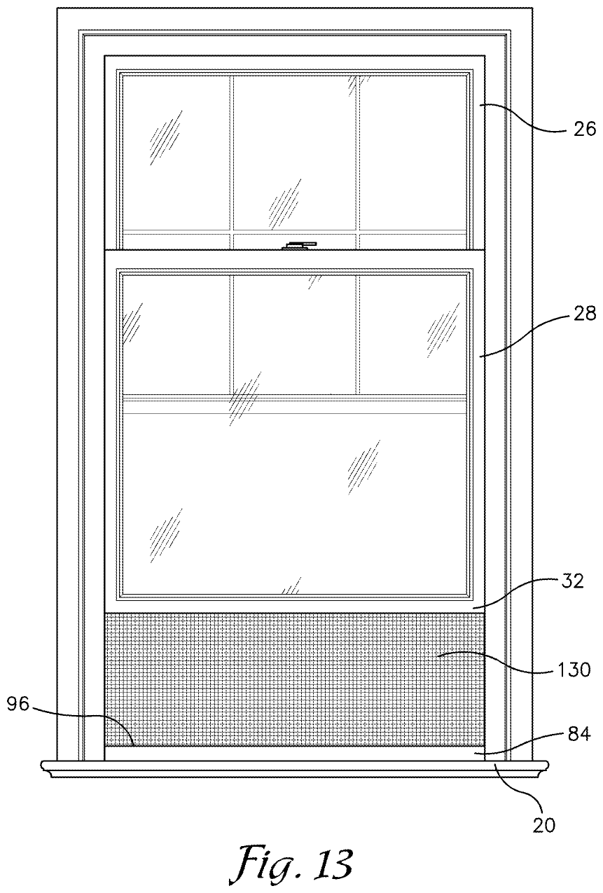

An alternative configuration, as seen in FIG. 13, reveals the cartridge housing 84 disposed atop the window sill 20. In this configuration, the cartridge housing 84, and the slot 96 of the third wall 94 is located immediately below the lower rail 32 of the window sash 28. This orientation eliminates angulation of the mesh 130 away from the jamb liners 38 as the sash is raised. If the window frame was not initially fabricated with an opening to house the cartridge 84 and major retrofitting of the window frame and associated wall structure is undesirable or possible due to, for example, structural complications or cost, placement of one cartridge atop the stool 24 of the window is an option with the design as disclosed herein.

Likewise, should the user have a desire to screen the space between the head jamb 18 and the top rail 30 of the outer sash 26 a cartridge 84 may be positioned against the head jamb 18 with the longitudinal slot 96 of the third wall facing downward allowing the mesh 130 wrapped around the longitudinally extending tube 40 to be extracted from the cartridge as the outer sash 26 is lowered to the desired location.

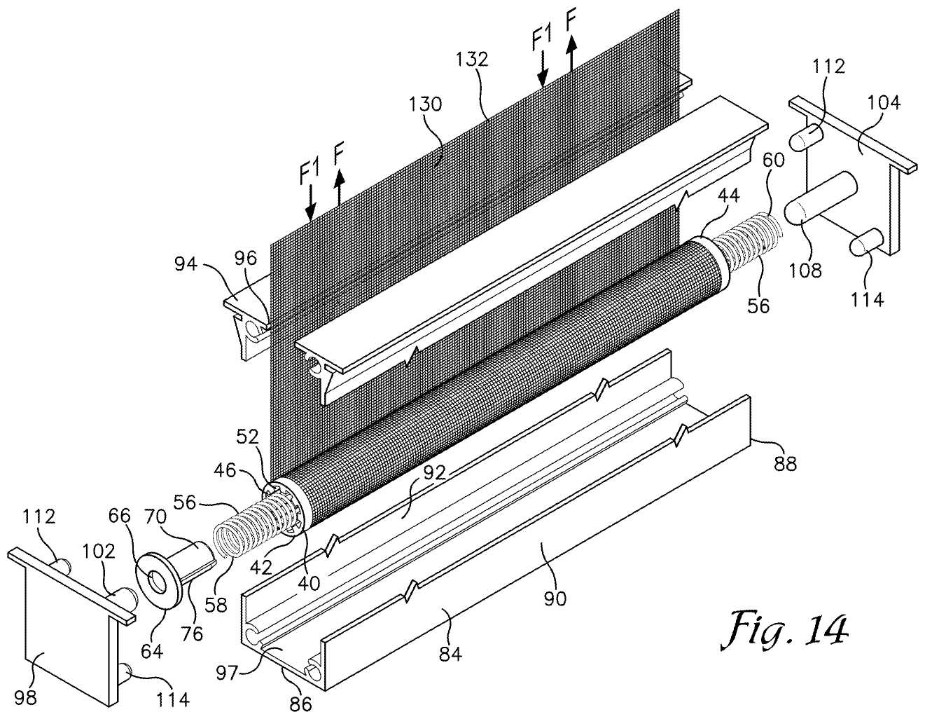

In the exploded view of FIG. 14, the extraction of the mesh screen 130 from the cartridge housing 84 by force F, generally a manually applied force, imparts a rotation to the longitudinally extending tube 44 and the spring 56. The second end 60 of the spring 56 is secured in position onto the rod 108 extending from the end cap 104. As the leading edge 132 of the mesh 130 is withdrawn from the cartridge 84, the extraction of the mesh causes the longitudinally extending tube 40 to rotate. While the first end 58 of the spring 56 is capable of rotation the second end 60 of the spring 56 is locked in position to the rod 108 and this configuration results in a spring that is wound continuously tighter as the mesh 130 is withdrawn by force F. This increasing tension in the spring 56 caused by the second end 60 of the spring being fixed and the connection of the spring 56 to the freely rotating end cap 64 at the first end seeks to draw the mesh 130 back into the cartridge and maintains a tension on the mesh.

Importantly, and as previously detailed, the first end 58 of the spring 56 is secured, with for example, glue or possibly by being press fit onto the second end 70 of the first end tube cap 64 hollow cylinder 66. The first end tube cap 64 is configured to freely rotate about the mounting rod 102 and the at least one key 76 is inserted into a slot or keyway 52 of the tube 40 to force the first end cap to rotate with the tube as force F is applied to the leading edge 132. The key 76 and keyway 52 engagement ensures that the end cap 64 will rotate about the mounting rod 102 because the force F applied to the leading edge 132, by the window operator, will cause the tube 40 to rotate and as the tube rotates so does the end cap 64 freely rotate about the mounting rod 102.

When the operator returns the window sash to the closed position a varying force F1 is applied to the screen 130 and to the leading edge 132 at the line of attachment of the leading edge to the sash rail. The force F1 is applied by the spring 56 and the force decreases as the leading edge 132 moves closer to the tube 40. The force F1 decreases because the spring 56 is returned to the spring's original, and unrotated position where no force F1, or possibly a very low level of force, is applied to the leading edge 132 of the mesh 130.

The apparatus disclosed herein operates by spanning and substantially covering an opening and as detailed above the spring 56 resists rotation of the longitudinally extending tube 40 and seeks to retract the mesh screen 130 back into the cartridge 84. In operation a torsional spring is preferred. The spring 56, as detailed above, resists rotation and is housed within the cartridge 84 that is mounted atop the window sill and/or beneath the head jamb of the window.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Moreover, the order of the components detailed in the system may be modified without limiting the scope of the disclosure.

We claim:

1. A cartridge containing a retractable screen structure configured for spanning and substantially covering an opening in a window, the cartridge comprising:
a longitudinally extending tube with a first end and a second end, the tube further comprising an interior channel with an inner diameter, an outer diameter and a plurality of spaced apart parallel slots extending longitudinally along the inner diameter;
a spring with a first and second end, the spring extending through the interior channel of the tube;
a first end tube cap for the first end of the longitudinally extending tube, the first tube end cap comprising a hollow cylinder with a first end, a second end, an outer radius, an inner radius and at least one key disposed on the outer radius for engagement with at least one of the spaced apart slots of the tube, wherein the first end of the spring is secured to the second end of the first end tube cap hollow cylinder and the first end of the hollow cylinder is mounted to a stop plate;
a longitudinally extending cartridge housing wherein the longitudinally extending tube is disposed within the cartridge housing, the cartridge comprising a first end and a second end, a pair of oppositely disposed side walls, a third wall extending between the side walls with a longitudinally extending slot therein and a fourth unslotted wall disposed opposite the slotted wall and extending between the side walls;
a first cartridge end cap for restraining the longitudinally extending tube in position within the cartridge housing, the end cap proximate the first end of the tube, the first cartridge end cap comprising a plate and a mounting rod extending perpendicularly outwardly from the plate, wherein the first cartridge end cap mounting rod is inserted into the hollow cylinder of the first tube end cap and the hollow cylinder is capable of freely rotating about the mounting rod;
a second cartridge end cap disposed proximate the second end of the longitudinally extending tube, the second cartridge end cap comprising a plate and a mounting rod extending perpendicularly outwardly from the plate, wherein the second end of the spring is secured to a distal end of the mounting rod; and
a mesh screen with a leading edge, a trailing edge and opposed side edges, the mesh screen of sufficient length and width to freely span and substantially cover the window opening when uncoiled, the mesh screen being wrapped around the longitudinally extending tube, the trailing edge of the mesh screen secured to the longitudinally extending tube and the leading edge routed through the longitudinally extending slot of the third wall of the cartridge housing for attachment to the rail of a window sash and the spring facilitating the unimpeded retraction of the screen mesh element when desired.

2. The cartridge containing a retractable screen structure configured for spanning and substantially covering an opening in a window of claim 1, wherein the extraction of the mesh screen from the cartridge imparts a rotation to the longitudinally extending tube and the spring.

3. The cartridge containing a retractable screen structure configured for spanning and substantially covering an opening in a window of claim 2, wherein the spring resists rotation of the longitudinal extending tube seeking to retract the mesh screen back into the cartridge.

4. The cartridge containing a retractable screen structure configured for spanning and substantially covering an opening in a window of claim 1, wherein the first and second cartridge end caps further comprise a first and second post extending perpendicularly outwardly from proximate two diagonally opposed corners of the end caps.

5. The cartridge containing a retractable screen structure configured for spanning and substantially covering an opening in a window of claim 4, wherein the first and second posts of the first and second cartridge end caps are received into channels in the first and second ends of the cartridge housing.

6. The cartridge containing a retractable screen structure configured for spanning and substantially covering an opening in a window of claim 1, wherein the spring is a torsional spring.

7. The cartridge containing a retractable screen structure configured for spanning and substantially covering an opening in a window of claim 1, wherein each of the opposed side edges of the mesh are disposed within oppositely disposed trackways for guiding the mesh as the mesh moves with the sash to which the second end of the mesh is attached.

8. The cartridge containing a retractable screen structure configured for spanning and substantially covering an opening in a window of claim 1, wherein the cartridge is disposed in a cavity below the window sill.

9. The cartridge containing a retractable screen structure configured for spanning and substantially covering an opening in a window of claim 1, wherein the cartridge is mounted atop the window sill.

10. The cartridge containing a retractable screen structure configured for spanning and substantially covering an opening in a window of claim 1, wherein the cartridge is mounted to the head jamb of a window.

11. A screen system for use with a sliding sash of a window to screen an opening as the sliding sash is opened, the system comprising:
a longitudinally extending tube with a first end and a second end, the tube further comprising an interior channel, an outer diameter and a plurality of keyways extending longitudinally along the inner diameter;
a spring with a first and second end, the spring extending through the interior channel of the tube;
a first end tube cap for the first end of the longitudinally extending tube, the first tube end cap comprising a hollow cylinder with a first end, a second end, an outer radius, an inner radius and at least one key disposed on the outer radius for engagement with at least one of the keyways of the tube, wherein the first end of the spring is secured to the second end of the end cap hollow cylinder and the first end of the hollow cylinder is mounted to a stop plate, the stop plate sized to cover the first end of the tube;
a longitudinally extending cartridge housing wherein the longitudinally extending tube is disposed within the cartridge housing, the cartridge comprising a first end and a second end, a pair of oppositely disposed side walls, a third wall extending between the side walls with a longitudinally extending slot therein and a fourth unslotted wall disposed opposite the slotted wall and extending between the side walls;
a first cartridge end cap for restraining the longitudinally extending tube in position within the cartridge housing, the end cap proximate the first end of the tube, the first cartridge end cap comprising a plate and a mounting rod extending perpendicularly outwardly from the plate, wherein the first cartridge end cap mounting rod is inserted into the hollow cylinder of the first tube end cap and the hollow cylinder is capable of freely rotating about the mounting rod;
a second cartridge end cap disposed proximate the second end of the longitudinally extending tube, the second cartridge end cap comprising a plate and a mounting rod extending perpendicularly outwardly from the plate, wherein the second end of the spring is secured to a distal end of the mounting rod; and
a mesh screen with a leading edge, a trailing edge and opposed side edges, the mesh screen of sufficient length and width to freely span and substantially cover the window opening when uncoiled, the mesh screen being wrapped around the longitudinally extending tube, the trailing edge of the mesh screen secured to the longitudinally extending tube and the leading edge routed through the longitudinally extending slot of the third wall of the cartridge housing for attachment to the rail of a window sash wherein the mesh screen can be unwound from the longitudinally extending tube as the sliding sash is opened, and wound back onto the tube as the sliding sash is closing.

12. The screen system of claim 11, wherein the cartridge is disposed in a cavity below the window sill fully obscured from view.

13. The screen system of claim 11, wherein the second end of the spring is press fit onto the distal end of the mounting rod.

14. The screen system of claim 13, wherein the press fit end of the spring remains stationary during unwinding of the mesh screen.

15. The screen system of claim 14, wherein the first end of the spring rotates freely during unwinding of the mesh screen.

16. The screen system of claim 11, wherein the stop plate is sized to cover the inner and outer radius of the first end of the tube and the stop plate is circular in configuration.

17. The screen system of claim 11, wherein the longitudinally extending tube is suspended within the cartridge housing by the mounting rods of the first and second cartridge end caps.

18. The screen system of claim 11, wherein the return force generated by the spring increases as additional mesh screen is withdrawn from the cartridge housing.

19. The screen system of claim 11, wherein each of the opposed side edges of the mesh are disposed within oppositely disposed tracks for guiding the mesh as the mesh moves with the sash to which the second end of the mesh is attached.

20. The screen system of claim 19, wherein the oppositely disposed tracks are comprised of a flexible material to maintain a compressive seal against the mesh as it is withdrawn from and retracted into the cartridge housing.
